(19) United States
(12) Patent Application Publication
(10) Pub. No.: US 2021/0224488 A1
(43) Pub. Date: Jul. 22, 2021

(54) BUSINESS GRAPH ENGINE FOR CONNECTION RECOMMENDATIONS

(71) Applicant: DevFactory FZ-LLC, Dubai Media City (AE)

(72) Inventors: Harsh Arya, Dubai Media City (AE); Ujjwal Jain, Dubai Media City (AE); Ashish Chauhan, Dubai Media City (AE)

(73) Assignee: DevFactory FZ-LLC, Dubai Media City (AE)

(21) Appl. No.: 16/749,449

(22) Filed: Jan. 22, 2020

(51) Int. Cl. G06F 40/49; G06N 5/02; G06F 16/9032; G06N 5/04; G06F 16/28; G06F 16/9536

(52) U.S. Cl. CPC G06F 40/49; G06N 5/02; G06F 16/9536; G06N 5/04; G06F 16/288; G06F 16/90332

(57) ABSTRACT

A method and apparatus are disclosed for recommending business connections by receiving connection network data from multiple social networking systems defining a first plurality of entities connected to at least a first user, preprocessing a newsfeed with NLP services to identify a second plurality of entities and topics in the newsfeed, generating a business graph data structure which defines a relationships map between the first user and the first and second plurality of entities, and applying query processing services to generate a search report in response to a search query, where the search report comprises a contact panel populated with business connection recommendations from the business graph data structure which correspond to the search query, and a news panel populated with one or more newsfeed articles which correspond to the search query and which are tagged with a sentiment score and one or more entity and topic tags.

### BACKGROUND

### Field

The present invention is directed in general to field of information processing. In one aspect, the present invention relates generally to social networking systems and related online connection networks.

### Description of Related Art

With the Internet enabling end-users operating computing devices to request content from different information sources, various sales and commerce applications have been developed which help sales professionals find new customers or contacts by using the Internet information sources to grow and develop both their own careers and business opportunities for their employers. For example, LinkedIn has a customer lead-generation solution, Sales Navigator, which allows users to a build and use a network of connections to find and build relationships with prospects and customers. However, once a new potential customer organization is identified, it can be very difficult to identify a specific decision maker within the organization to contact since ideally, people interested in affecting the actions of organizations attempt to talk to the most influential persons within that organization. In addition, the ability to identify potential leads with such solutions is constrained by the number of connections in the user's network. And while there are automated customer relationship management (CRM) processes and systems for managing an end-user's interactions with business contacts, clients, contract wins, sales leads, such solutions do not typically provide sales intelligence to assist with suggesting accounts or leads. As a result, the existing customer lead-generation solutions are extremely difficult at a practical level by virtue of the difficulty in quickly and efficiently find connections and leads to qualified potential customers based on an understanding of customer connections and target business markets.

### SUMMARY

A system, apparatus, and methodology are described for efficiently finding and organizing business-relevant connection recommendations with relevant and timely sales intelligence by aggregating corporate and newsfeed data with business network connection services into a single view using a business graph database to provide a relationship map of companies, people, and their relationships. In selected embodiments, the business graph database is constructed as a relationship map of business entities and relationships which are extracted by using network connection identification services to find business connections for one or more employees at a company and by applying NLP processing of newsfeed and corporate data to provide sales intelligence information (e.g., newsfeed articles) which are tagged with sentiment scores, entities and topics and entities for improved searching of business connections. When implemented as a software as a service (SaaS) model, the business-relevant connection recommendation system provides a sophisticated, infinitely scalable big data platform which combines up-to-date and relevant corporate data and newsfeed information with recommended connections from LinkedIn and Facebook network connection identification services for all company employees to target customers with reduced time, lower costs, and high quality outcomes for identifying leads that are a good fit for the company's product/service. In selected embodiments, any suitable natural language processing (NLP) techniques may be used to assist with applying user search queries, accessing the business graph database for business connection recommendations, and annotating corporate data and/or newsfeed information, such as by parsing the search terms, applying fuzzy search functionality, performing text classification on newsfeed information to identify topic and entity information in the newsfeed data, and/or performing sentiment analysis of newsfeed data. By aggregating the business connection network data for all company employees with sentiment, topic, and entity data on target companies (e.g., corporate structure, number of employees, org chart, competitors, current news, etc.), data search reports may be generated to provide users with personalized insight into their business world using visualizations which list contact recommendations along with selected news stream excerpts to highlight trends and clusters, anomalies, dynamic linkages and connections in response to user search queries.

The objects, advantages and other novel features of the present invention will be apparent from the following detailed description when read in conjunction with the appended claims and attached drawings.

### BRIEF DESCRIPTION OF THE DRAWINGS

FIG. 1 is a simplified block diagram of a data processing system for aggregating corporate and newsfeed data with business network connection services to find and organize business-relevant connection recommendations in accordance with selected embodiments of the present disclosure.

FIG. 2 illustrates a block diagram of functional components of a business graph recommendation system in accordance selected embodiments of the present disclosure.

FIG. 3 illustrates a simplified flow chart showing the logic for generating a report with business network connection recommendations and supporting newsfeed information in accordance selected embodiments of the present disclosure.

FIG. 4A is a first example screen shot of a user interface generated by a business graph recommendation engine which includes an aggregated view of newsfeed data and business network connection recommendations in response to a user search query in accordance selected embodiments of the present disclosure.

FIG. 4B is a second screen shot of a user interface generated by a business graph recommendation engine which includes an aggregated view of an organizational chart and business network connection recommendations in response to a user search query in accordance selected embodiments of the present disclosure.

FIG. 5 is a graphical depiction of a business graph showing connected nodes and edge connections in accordance selected embodiments of the present disclosure.

FIG. 6 is a simplified block diagram of a general-purpose computer in accordance with selected embodiments of the present disclosure.

### DETAILED DESCRIPTION

A business graph connection recommendation engine, methodology, system, program control code, and apparatus are described for efficiently and accurately identifying and organizing business-relevant connection recommendations and supporting sales intelligence in response to customer searches by using a business graph database to combine multiple business network connection services for all employees of a company with timely and relevant newsfeed analysis that is tagged with sentiment analysis and related topic/entity tagging, thereby generating search reports which list contact recommendations along with selected news stream based on a personalized insight into the customer's business world. As disclosed herein, a mapping process may use employee connection data (e.g., from LinkedIn or Facebook connection services) along with entity and/or topic data extracted from corporate and newsfeed data to form a business graph data structure having nodes (e.g., Company, BNews, Tweet, TweetUser, BusinessLine, IndustryFilter, Tag, Topic, FacebookUser, LinkedinUser, WGCompany, WGPerson, People, Region, Catsearch) and connecting edges which define the relationships between the nodes (e.g., competitors, associates, subsidiaries, affiliates, Facebook or Linkedin connections, shared business lines, sectors, or industries). In addition, one or more NLP processes may be applied to extract entity and/or topic data from the corporate data and/or newsfeed information for the mapping service, and to assist with user search queries and report generation.

While various details are set forth in the following description, it will be appreciated that the present invention may be practiced without these specific details. For example, selected aspects are shown in block diagram form, rather than in detail, in order to avoid obscuring the present invention. Some portions of the detailed descriptions provided herein are presented in terms of algorithms or operations on data within a computer memory. Such descriptions and representations are used by those skilled in the data processing arts to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that throughout the description, discussions using terms such as processing, computing, calculating, determining, displaying or the like, refer to the action and processes of a computer system, or similar electronic computing device, that manipulates and/or transforms data represented as physical, electronic and/or magnetic quantities within the computer system's registers and memories into other data similarly represented as physical quantities within the computer system memories or registers or other such information storage, transmission or display devices.

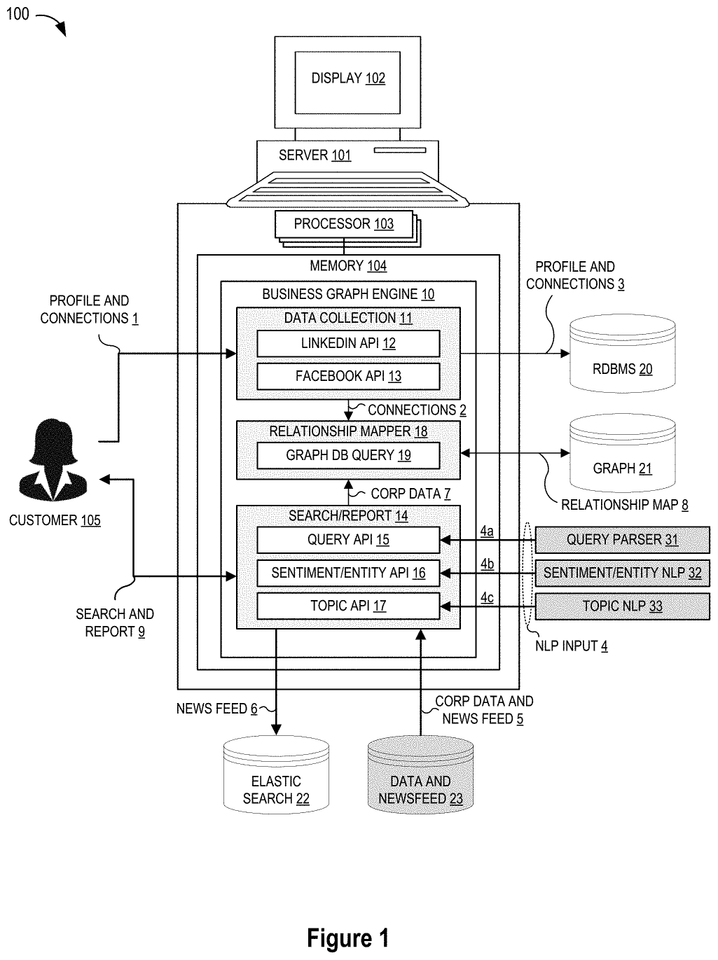

To provide additional details for an improved understanding of selected embodiments of the present disclosure, reference is now made to FIG. 1 which shows a simplified block diagram of an example data processing system 100 which aggregates corporate and newsfeed data with business network connection services to find and organize business-relevant connection recommendations. As illustrated, the data processing system 100 includes one or more server/computer systems 101 having a display 102, processor(s) 103, memory 104, and associated database storage devices 20-23 which may be connected together over suitable connection network or links, such as a private wide area network (WAN) or the Internet (not shown). To illustrate the operative functionality of the data processing system 100, the server memory 104 may store a program module functionality for the business graph engine 10 which receives and transforms input data sources to construct a business graph which is aggregated with corporate and newsfeed data to generate search reports for the customer 105. In particular, the business graph engine 10 may be configured with a data collection module 11 and search/report module 14 that are connected to transform input data sources 1, 5 into connections 2 and corporate data 7 that are mapped by the relationship mapping module 18 into a mapped relationship data 8 for storage in the business graph database 21 and for use in generating search reports 9 for the customer 105.

Examples of input data sources include, but are not limited to, account profile and connection information 1 provided by customer 105, such as LinkedIn and Facebook connection contacts. For example, the customer 105 may request/download connection contacts directly from their LinkedIn and Facebook accounts using the data collection module 10 which provides a web portal for data input. To leverage the power of other employees at the company, the data collection module 10 may also be used to load connection contacts from other employee at the company using the web portal provided by the business graph engine 10. The input account profile and connection contacts may be archived in a relational database management system (RDBMS) 20 or other suitable data storage. Additional input data sources may include corporate data and/or newsfeed data 5 provided by the database storage device 23. For example, the database storage device 23 may be embodied with a First Rain Legacy database 23 which stores corporate data and news feed information from a variety of web sources, including corporate data (e.g., Company, Person, BusinessLine, IndustryFilter, Region, Topic), news and tweets (e.g., News, Tweets, Tweet User, Tag), organization structure data (e.g., fellow employees of the customer 105), and the like. The input newsfeed may be stored in a suitable database management system (DBMS) 23 or other suitable data storage.

The operation of the business graph engine 10 to transform input data sources 1, 4, 5 into entity/relationship maps 8 is performed by the data collection module 11, search/report module 14, and relationship mapping module 18 which may include one or more application programming interface (API) services. For example, the data collection module 11 may include one or more connection APIs, such as a LinkedIn API 12 or Facebook API 13, which apply NLP techniques to parse the input account profile and connection data 1 and generate therefrom the connections data 2. In similar fashion, the search/report module 14 may include one or more APIs 15-17 that are connected to invoke NLP services 31-33 for processing the search inquiries and/or newsfeed or corporate data to provide NLP inputs 4. For example, a query API 15 may be connected to invoke an external query parser service 31, such as Amazon Lex, which applies NLP techniques for parsing customer queries to provide NLP parsed query parameters 4a, such as intents and their utterances, thereby enabling users to submit search queries using natural language phrasing. In addition or in the alternative, the search/report module 14 may include a sentiment/entity API 16 which is connected to invoke an external sentiment/entity NLP service 32, such as Google NLP, which applies sentiment analysis to calculate sentiment scores 4b from the from the newsfeed and/or corporate data, and which may also apply classification techniques to extract entity information 4b from the newsfeed and/or corporate data. The NLP input results 4b from the sentiment/entity NLP service 32 may be cached as news feed data 6 in the elastic search database 22 for use in serving customer queries. In addition or in the alternative, the search/report module 14 may include a topic API 17 which is connected to invoke an external topic NLP service 33, such as CodeNation Cognition, which identifies calculated topics in the newsfeeds and/or provides a knowledge graph 4c for performing semantic searching which improves search results by resolving company names from aliases.

Based on the connections data 2 and the corporate data 7, the relationship mapping module 18 generates a relationship map 8 having a business graph data structure which holds all entities and relationships modeled by the data processing system 100. For example, the relationship map 8 may be constructed include entity nodes (e.g., Company, BNews, Tweet, TweetUser, BusinessLine, IndustryFilter, Tag, Topic, FacebookUser, LinkedinUser, WGCompany, WGPerson, People, Region, Catsearch) and connecting edges which define the relationships between the nodes (e.g., competitors, associates, subsidiaries, affiliates, Facebook or Linkedin connections, shared business lines, sectors, or industries). In selected embodiments, the relationship map 8 may be optimized for querying entities and relationships therebetween, such as by using the Neo4j graph database management system 21 to store the relationship map 8. A graph database structure for the relationship map 8 has the advantage of allowing quicker and more efficient querying of relationships between entities compared to an RDBMS which would have required costly joins to access the same data.

Once the relationship map 8 is constructed and stored in the graph database 21, the search/report module 14 provides a search and report functionality for the customer which uses NLP processing techniques which are augmented with the relationship map 8 in the business graph database 21 to query the corporate data and newsfeeds 23 directly or based on relationships (e.g., business competitors) using the business network connections 2 extracted from the customer 105 and related employees. In selected embodiments, queries from the customer 105 are parsed at the search/report module 14 using the query parser 31 which provides a natural language query interface so that users can structure complex queries in an intuitive way (e.g., “Who are the competitors of IBM in India?”) as compared to forcing the user to build a query from a dynamically expanding/collapsing set of UI components (e.g., dropdowns, text boxes, etc.). “IBM” is a registered trademark of International Business Machines Corporation.

Additional support for intuitive search query functionality in the search/report module 14 is provided by including fuzzy search capabilities to recognize misspelled words, acronyms, synonyms in the search queries. To this end, the search/report module 14 may be configured to create entity-to-graph node ID mappings within an elastic search (ES) database 22 and then use ES's fuzzy search ability to search for the query entities. The resulting graph node ID is then used to access the business graph database 21 when querying the relationship map 8. While the search/report module 14 could be modified to implement support for misspellings, acronyms, and synonyms for using the native string search capabilities of the Neo4J graph database 21, the fuzzy search engine functionality from the ES database 22 provides good fuzzy search support in a leading open source project, thereby simplifying the complexity and reducing system costs.

In addition to providing support for intuitive search queries, the search/report module 14 is configured to generate query responses which are provided to the customer 105 as search reports 9 which include business connection recommendations and related sales intelligence data identified from the corporate data and newsfeed information 23. To this end, the search/report module 14 includes a graph database query module 19 which is configured to query entities and relationships from the business graph relationship map 21 that are related to the customer query. In addition, the search/report module 14 is configured to provide search corporate data and newsfeed information that is responsive to customer queries. To this end, the search/report module 14 may be configured to provide sentiment analysis of news feeds and to identify topics and entities within the feeds for improved search results. For example, the search/report module 14 may derive sentiment scores, topics, and entities from news feeds using Google Natural Language (sentiment, entities) and CodeNation Cognition (topics), and then store the news feeds and derived data in the ElasticSearch database 22. By generating sentiment scores along with entity and topic tags for responsive newsfeed data provided in the search reports 9, the search/report module 14 enables the customer 105 to understand the current state of the customer's business by quickly viewing recent articles that provide positive and/or negative information about a target company or person.

Illustrated as being stored in memory 104, the business graph engine 10 may be configured to assess customer search queries 9 against input data sources—including a relationship map 8 stored in the business graph database 21 and newsfeed and corporate data stored in the elastic search database 22 and data and newsfeed database 23—for purposes of generating query search reports with an aggregated single view of contact recommendations along with selected news stream excerpts that are tagged with sentiment scores, entities, and topics to highlight trends and clusters, anomalies, dynamic linkages and connections in response to user search queries. The configuring of the business graph engine 10 may include providing application specific hardware, firmware, or the like to facilitate the performance of the operations and generation of the outputs described herein with regard to the illustrative embodiments. In addition or in the alternative, the configuring of the business graph engine 10 may include storing software applications in one or more storage devices and loaded into memory of a computing device, such as server 101, for causing one or more hardware processors (e.g., 103) of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

As will be appreciated, once the server/computer system 101 is configured to implement the business graph engine 10, the server/computer system 101 becomes a specialized computing device specifically configured to implement the mechanisms of the illustrative embodiments and is not a general-purpose computing device. Moreover, as described hereafter, the implementation of the mechanisms of the illustrative embodiments improves the functionality of the computing device and provides a useful and concrete result that facilitates the generation of business connection recommendations for a sales representative customer 105 by allowing sales reps to obtain data on target companies (e.g., corporate structure, number of employees, org chart, competitors, current news, etc.) and to identify business connections in the organization they or their colleagues have connections to on LinkedIn (primary) and Facebook (secondary).

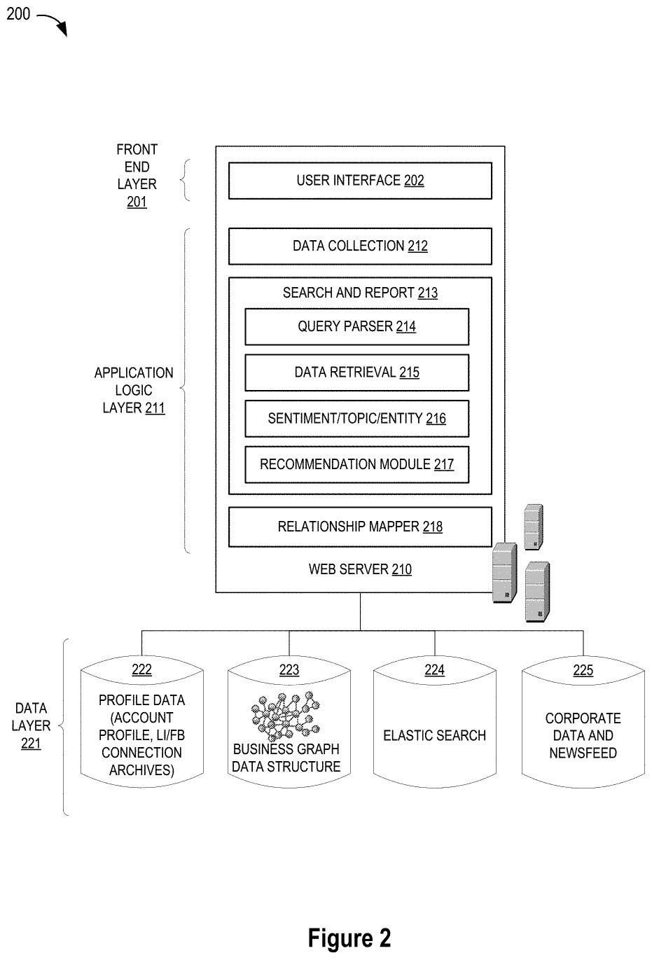

To provide additional details for an improved understanding for selected embodiments of the present disclosure, reference is now made to FIG. 2 which is a block diagram illustration of functional components of a business graph recommendation system 200. As shown in FIG. 2, the business graph recommendation system 200 can include data processing modules that are distributed across different layers, such as a front-end layer 201, application logic layer 211, and data layer 221. As will be appreciated, the modules and systems shown in FIG. 2 represent a set of executable software instructions and the corresponding hardware (e.g., memory and processor) for executing the instructions on one or more web servers 210. However, to avoid obscuring the description with unnecessary detail, various functional modules and systems that are not germane to conveying an understanding of the present disclosure have been omitted. As such, persons skilled in the art will recognize that additional functional modules and systems may be used with the business graph recommendation system 200 to facilitate additional functionality that is not specifically described herein. Furthermore, the various functional modules and systems depicted in FIG. 2 may reside on a single web server computer, or may be distributed across several server computers in various arrangements. Moreover, although the business graph recommendation system 200 is depicted as a three-tiered architecture, the business graph recommendation system is not limited to such architecture. It is contemplated that other types of architecture are within the scope of the present disclosure.

As shown in FIG. 2, selected embodiments of the front-end layer 201 may include a user interface module 202, such as a web server interface which receives requests and inputs from various client-computing devices, and communicates appropriate responses to the requesting client devices. For example, the user interface module(s) 202 may receive requests in the form of Hypertext Transfer Protocol (HTTP) requests, or other web-based API requests. In addition, the user interface module(s) 202 may receive, from client devices, search requests from sales agents and requests to present recommended sales leads along with supporting sales intelligence responsive to the search requests. The responses to such requests may be transmitted by the business graph recommendation system 210 to the requesting client devices for display by the client devices.

In addition, the depicted application logic layer 211 may include one or more modules for implementing the data collection, search/report, and relationship mapping functions. For example, the application logic layer 211 may include the data collection module 212, the search and report module 213, and the relationship mapper module 218, which, in conjunction with the user interface module(s) 202, generate various user interfaces (e.g., web pages) with data retrieved from various data sources in the data layer 221. In selected embodiments, the data collection module 212 is used to collect account profile information and business connection contact data from the customer/user. For instance, LinkedIn and Facebook connection information is retrieved by the data collection module 212 for incorporation into the business graph 223. In addition, the data collection module 212 may collect account profile information and/or business connection contact data from other employees at the company where the customer/user works. For archive purposes, the collected account profile and business contact data may be stored in the profile database 222.

In addition to being archived in the profile database 222 of the data layer 221, the collected connection data is processed by the relationship mapper module 218 to form a business graph data structure 223 that is stored in the data layer 221 to hold all entities and relationships modelled by the business graph recommendation system 200. The processing by the relationship mapper module 218 may also populate the business graph data structure 223 with entities and topics extracted from the newsfeed and corporate data database 225 by the search and report module 213. To this end, the search and report module 213 may include a data retrieval service 215 for loading newsfeed/corporate data from the corporate data and newsfeed database 225. In addition, the search and report module 213 may include or invoke one or more NLP tools 216 to evaluate the newsfeed and/or corporate data 215. With a first embodiment employing a Google NLP tool 216, the search and report module 213 may calculate a sentiment score and/or identify one or more entities in the newsfeed or corporate data 215. In addition or in the alternative, a second embodiment employing a CodeNation cognition NLP tool 216, the search and report module 213 may identify one or more topics in the newsfeed or corporate data 215. For purposes of archiving or storing the newsfeed and derived NLP data results in a format that is suitable for efficiently generating search results, the search and report module 213 may store the newsfeed and NLP data results in the elastic search database 224 of the data layer 221.

In addition to using the newsfeed and corporate data to populate the business graph data structure 223, the search and report module 213 also processes customer queries to generate search reports. To this end, the search and report module 213 may include or invoke a query parser service 214, such as Amazon Lex or other suitable natural language query interface, for enabling customers to ask complex queries in an intuitive way. In addition, the search and report module 213 may employ fuzzy search techniques when processing customer queries to account for misspellings, acronyms, and synonyms in the query.

To generate the search report, the search and report module 213 may include a recommendation module 217 that provides recommended business leads to customers in a user interface or display which aggregates corporate and newsfeed data with business network connection services into a single view using a business graph database to provide a relationship map of companies, people, and their relationships. In selected embodiments, the lead recommendation module 217 blends multiple business connection services (e.g., Facebook and LinkedIn) with newsfeed search results that are tagged with sentiment scores, entities and topics to recommend sales prospects generated from the business graph 223, thereby providing customers with personalized insight into their business world using an aggregated visualization which lists contact recommendations along with selected news stream excerpts to highlight trends and clusters, anomalies, dynamic linkages and connections in response to user search queries.

To provide an illustrative example of how a customer query is serviced by the business graph recommendation system 200, the user interface module 202 may be operatively configured to provide a search bar for the user or customer to enter a search query in a natural language format (e.g., “competitors of jnj in japan”). The search and report module 213 then sends the query to the query parser service 214 to determine the intent and utterance for the query. In this example search query, the identified intent is:
a. Intent—CompetitorsInRegion
b. Slots
   i. Region—Japan
   ii. Company—jnj

To resolve the query term ‘jnj’ to the appropriate entity for the semantic search, the search and report module 213 may use the data retrieval module 215 to access the previously-stored newsfeed data in the Elastic Search database 224 and knowledge graph to resolve the “jnj” entity to “Johnson and Johnson.” With this additional information, the recommendation module 217 may generate a search report which lists contact recommendations in a Contact Panel along with selected news stream excerpts in a News Panel. In particular, the recommendation module 217 may invoke the data retrieval module 215 and NLP tools module 216 to populate the News Panel with one or more news reports where “Johnson and Johnson” is mentioned along with its competitors in the latest news, along with the corresponding sentiment score and entity or topic tags. In addition, the recommendation module 217 may invoke the data retrieval module 215 and relationship mapper module 218 to populate the Contacts Panel with a list of one or more people working in competitors of “Johnson and Johnson” whom the user can reach directly through his business connections or with the help of the business connections of his colleagues.

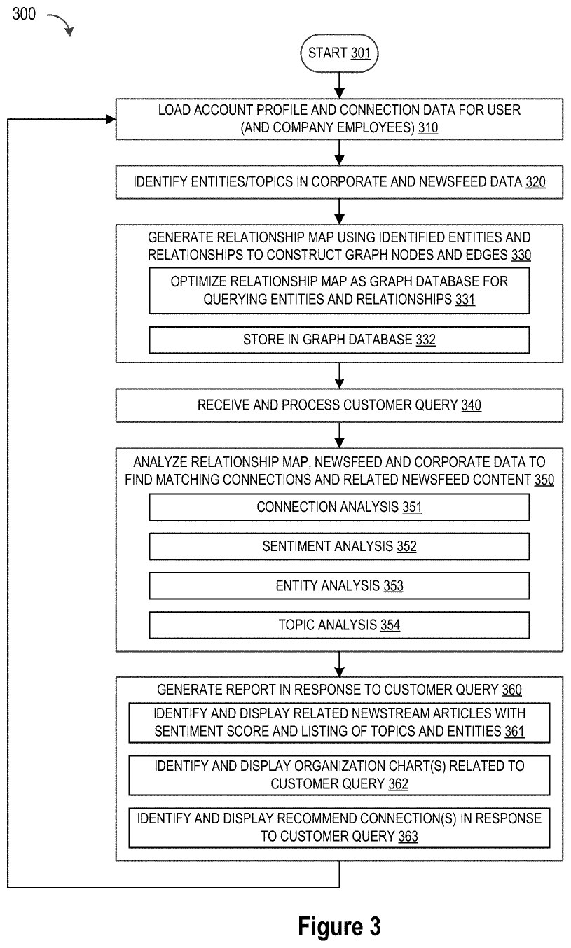

To provide additional details for an improved understanding of selected embodiments of the present disclosure, reference is now made to FIG. 3 which depicts a simplified flow chart 300 showing the logic for generating a report with business network connection recommendations and supporting newsfeed information. The processing shown in FIG. 3 may be performed by a web server system, such as the data processing system 100 shown in FIG. 1 or other natural language processing system.

At step 301, the process begins, such as when a user is onboarded with a sales tool which employs the business graph recommendation engine to making business connection recommendations. At step 310, information related to a user of the sales tool is retrieved and loaded, such as by loading a user's account profile and connection data from different social networking services (e.g., LinkedIn and Facebook connection services). To leverage the business connections of other company employees, the processing at step 310 may also load connection data for affiliated employees. The processing performed at step 310 may be performed by the data processing system 100 shown in FIG. 1 or other computer system having a user interface and data collection functionality for loading connection data.

At step 320, one or more entities and or topics are identified in corporate data and/or newsfeed which may be stored in a suitable database and/or retrieved with a separate crawler service to periodically fetch latest news and tweets. Using an NLP classifier service, such as Google NLP, the identified entities and topics can include, for example, persons, companies, regions, tags, topics, BNews, Tweet, TweetUser, BusinessLine, IndustryFilter, Tag, Topic, FacebookUser, LinkedinUser, WGCompany, WGPerson, People, Region, Catsearch, accounts and/or contacts. In addition, the news data may be augmented with metadata like sentiments of news, entities present in the news, and topics with the help of Google and CodeNation Cognition NLP services and then saved in a suitable database. The processing performed at step 320 may be performed by the data processing system 100 shown in FIG. 1 or other computer system having a data retrieval and NLP processing functionality for identifying entity and topic information in the corporate data and newsfeed.

At step 330, a relationship map is generated, such as by using the relationship mapping module which processes the entities and relationships extracted at steps 310, 320 to construct, respectively, graph nodes and graph edges which specify relationships between the graph nodes. While any suitable relational map format may be used, selected embodiments of the present disclosure optimize the relationship map at step 331 as a graph database which is optimized for querying entities and relationships therebetween, thereby being well suited for target queries that are based on relationships (e.g., person to person, person to company, company to company, etc.). At step 332, the optimized relationship map may be stored in a graph database, such as the Neo4J or Amazon Neptune database systems. In selected embodiments, the Neo4J provides an open source project with business-friendly license terms and a straightforward query language that supports efficient querying of relationships between entities. The processing performed at step 330 may be performed by the data processing system 100 shown in FIG. 1 or other computer system having a relationship mapping functionality for constructing a graph database from the identified entity and relationships.

At step 340, a customer query is received and processed, such as by using the search and report module. While any suitable query processing techniques may be used, a natural language processing tool, such as Amazon Lex, allows users to query data using natural language search terms by evaluating the query to identify the intents and utterances contained therein. In addition, query processing may be assisted by deploying fuzzy searches to implement support for misspellings, acronyms, and synonyms in the search query. The processing performed at step 3440 may be performed by the data processing system 100 shown in FIG. 1 or other computer system having the required NLP processing functionality for processing customer queries.

At step 350, the relationship map, newsfeed, and corporate data are analyzed to find matching connections and related newsfeed content that correspond to the search query. In particular, a connection analysis service 351, such as a graph database query functionality, may be applied to find entities and relationships in the relationship map that correspond to the search query. In addition or in the alternative, a sentiment analysis service 352, such as Google NLP, may be applied to perform sentiment analysis on articles in the newsfeed stream that correspond to the search query. In addition or in the alternative, an entity analysis service 353, such as an NLP classifier service, may be applied to identify or classify entities from the newsfeed stream that correspond to the search query. In addition or in the alternative, an topic analysis service 354, such as an CodeNation Cognition, may be applied to identify topics from the newsfeed stream that correspond to the search query. The processing performed at step 350 may be performed by the data processing system 100 shown in FIG. 1 or other computer system having the required search and report processing functionality to find matching connections and newsfeed content.

At step 360, a report is generated in response to the customer query. In the generated report, an aggregated visualization may be provided which identifies and displays newstream articles that are related to the customer search query, and that include a corresponding sentiment score and listing of topics and entities (step 361). In addition or in the alternative, the aggregated visualization may identify and display one or more organization charts that are related to the customer search query (362). In addition or in the alternative, the aggregated visualization may identify and display one or more recommended connections in response to the customer search query (363). The processing performed at step 360 may be performed by the data processing system 100 shown in FIG. 1 or other computer system having the required display generation functionality to generate and send the search report with an aggregated visualization of connection recommendations and related newsfeed articles.

After step 360, the process returns back to step 310 to capture any updates to the user's connection data or other input sources. For example, any updates to the user's LinkedIn or Facebook contacts is processed in the background to update the business graph database. In addition, any update (creation/updating/deletion) of a record in the corporate data and newsfeed database is captured and the business graph database is updated accordingly.

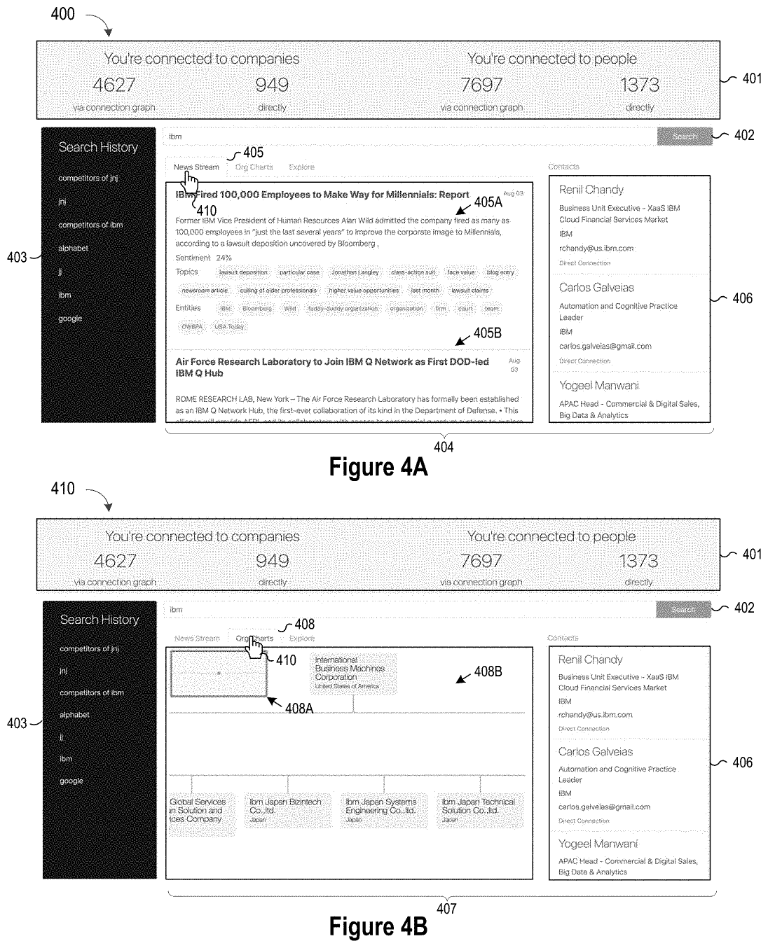

To provide additional details for an improved understanding of selected embodiments of the present disclosure, reference is now made to FIGS. 4A-C which depict an example sequence of user interface screen shots generated by a business graph recommendation engine in accordance selected embodiments of the present disclosure. In the first example shown in FIG. 4A, there is displayed a first screen shot of a user interface 400 which includes an aggregated view of newsfeed data and business network connection recommendations in response to a user search query. In particular, the user interface 400 includes a connection summary panel 401 which lists the people and businesses connected to the user, either directly or through the business graph. In addition, the user interface 400 includes a search bar window 402 wherein the user may enter a search term (e.g., “ibm”) which is processed to generate search results, along with a search history panel 403 which shows the user's previous search queries. In response to the search query entered by the user, the user interface 400 also includes an aggregated view 404 which, when activated by the cursor 410, displays a newsfeed data panel 405 in combination with a business network connection recommendations panel 406, thereby improving the performance and efficiency of the computer system so that separate display panels need not be separately generated. In the example of FIG. 4A, the newsfeed data panel 405 displays excerpted newsfeed articles 405A, 405B relating to the search query, each of which is tagged with a corresponding sentiment score and one or more tagged topics and entities from the newsfeed article. In addition, the business network connection recommendations panel 406 displays one or more contact recommendations relating to the search query which were retrieved by querying the business graph database, where each contact recommendation entry includes identifying connection information, such as the name, title, employer, and email address.

By using the cursor 410 or other user interface controls to interact with the user interface 400, the user may cause the business graph recommendation engine to display a second user interface screen shot 410 which includes an aggregated view of an organizational chart and business network connection recommendations in response to a user search query, as illustrated in FIG. 4B. In this example, the user interface 410 includes the connection summary panel 401, search bar window 402, and search history panel 403. However, the user interface 410 also includes an aggregated view 407 which, when activated by the cursor 410, displays an organization chart panel 408 in combination with a business network connection recommendations panel 406. In the example of FIG. 4B, the organization chart panel 408 displays a reduced or thumbnail view of the org chart 408A along with an enlarged or zoomed view of the org chart 408B for the company identified by the search query. In addition, the business network connection recommendations panel 406 displays the contact recommendation(s) relating to the search query which were retrieved by querying the business graph database.

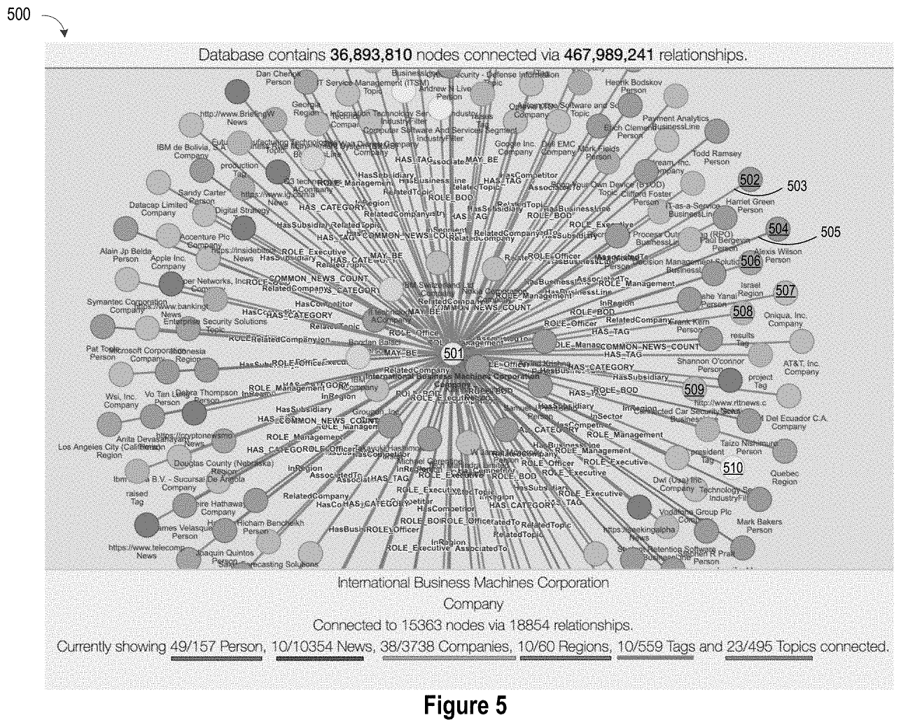

To provide additional details for an improved understanding of selected embodiments of the present disclosure, reference is now made to FIG. 5 which shows a graphical depiction 500 of a business graph having a plurality of connected nodes (e.g., 36,893,810) and edge connections (e.g., 467,989,241). In the illustrated example, the displayed business graph 500 shows that a company identified by search query (e.g., International Business Machines) is represented at a first graph node 501. The business graph 500 also shows that the first grant node 501 is connected to a plurality of graph nodes representing different entities via a plurality of edges which represent relationships between the entities. For example, the first graph node 501 (representing the company, IBM®) is connected to a second graph node 502 (representing the person, Harriet Green) over a first edge 503. In addition, the first graph node 501 (representing the company, IBM®) is also connected to a third graph node 504 (representing the person, Alexis Wilson) over a second, different edge 505. As illustrated, the first graph node 501 for IBM® is connected to 15,363 nodes (entities) via 18,854 relationships (edges), of which the depicted view shows 49/157 “person” entities, 10/10,354 “news” entities, 38/3,738 “company” entities, 10/60 “region” entities, 10/559 “tag” entities, and 23/495 “topic” entities. However, the IBM®-related nodes are only a subset of the overall business graph database which includes 36,893,810 nodes (entities) connected by 467,989,241 relationships (edges)

With each graph edge indicating a relationship between two graph nodes that may be derived from different connect services (e.g., LinkeIn and Facebook), the business graph 500 may provide visually distinct depictions of the edges to indicate the source of the relationship information. For example, it may be important for end users to know whether relationships are based on LinkedIn or Facebook connections so it is a common query parameter. In selected embodiments, the business graph 500 includes independent edges, one for LinkedIn and one for Facebook. Alternatively, the business graph 500 may include a single edge which has an attribute (e.g., color) denoting LinkedIn, Facebook, or both. In the example of FIG. 5, the edges are colored blue to indicate a LinkedIn connection, and are colored gray to indicate a Facebook connection.

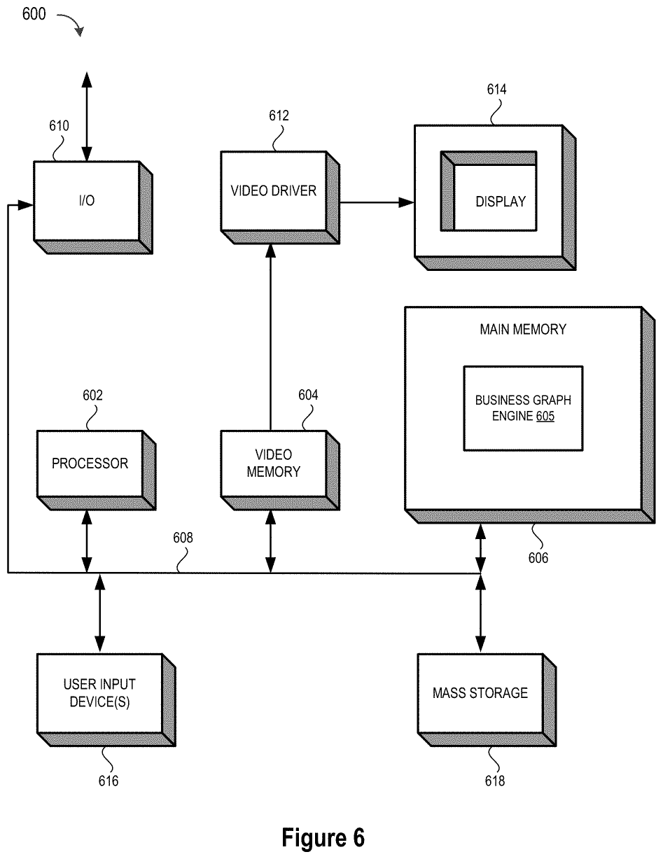

Embodiments of the system and method for recommending business connections can be implemented on a computer system, such as a general-purpose computer 600 illustrated in FIG. 6. As disclosed, the computer 600 includes input user device(s) 616, such as a keyboard and/or mouse, which are coupled to a bi-directional system bus 608. The input user device(s) 616 are used for introducing user input to the computer system 600 and communicating that user input to processor 602. The computer system 600 may also include a video memory 604, main memory 606, and mass storage 618, all coupled to bi-directional system bus 608 along with input user device(s) 616 and processor 602. The mass storage 618 may include both fixed and removable media, such as other available mass storage technology. Bus 608 may contain, for example, 32 address lines for addressing video memory 604 or main memory 606. The system bus 608 may also include, for example, an n-bit data bus for transferring data between and among the components, such as CPU 602, main memory 606, video memory 614, and mass storage 618, where “n” is, for example, 32 or 64. Alternatively, multiplex data/address lines may be used instead of separate data and address lines.

The computer 600 may also include I/O device(s) 610 which provide connections to peripheral devices, such as a printer, and may also provide a direct connection to remote server computer systems via a telephone link or to the Internet via an ISP. I/O device(s) 610 may also include a network interface device to provide a direct connection to remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in mass storage 618 until loaded into main memory 606 for execution. Computer programs may also be in the form of electronic signals modulated in accordance with the computer program and data communication technology when transferred via a network. The method and functions relating to system and method for generating business connection recommendations may be implemented in a computer program for a business graph engine 605.

The processor 602, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 606 is comprised of dynamic random access memory (DRAM). Video memory 604 is a dual-ported video random access memory. One port of the video memory 604 is coupled to video amplifier or driver 612. The video amplifier 612 is used to drive the display 614. Video amplifier 612 is well known in the art and may be implemented by any suitable means. This circuitry converts pixel data stored in video memory 604 to a raster signal suitable for use by display 614. Display 614 is a type of monitor suitable for displaying graphic images.

By now, it will be appreciated that there is disclosed herein a system, method, apparatus, and computer program product for enhancing operable functionality of a software program for making business connection recommendations. As disclosed, the system, method, apparatus, and computer program are performed by a device having a business connection recommendation engine where the device receives connection network data from first and second social networking systems, where the connection network data defines a first plurality of entities connected to at least a first user by a plurality of social network connections. In selected embodiments, the first and second social networking systems are a LinkedIn system and a Facebook system. In other embodiments, the connection network data defines the first plurality of entities connected to the first user and/or to one or more additional employees of a company that employs the first user. Subsequently, the device preprocesses newsfeed and/or corporate data with a plurality of natural language processing services to identify a second plurality of entities and topics in the newsfeed and/or corporate data. In selected embodiments, the newsfeed and/or corporate data is preprocessed by applying natural language processing services selected from a group consisting of a sentiment analysis service, a classification service, and a topic identification service. In other embodiments, the newsfeed and/or corporate data is preprocessed by applying natural language processing services selected from a group consisting of a Google NLP service and a CodeNation cognition service. In addition, the device generates a relationship map as a business graph data structure which defines relationships between at least the first user and each entity in the first plurality of entities and the second plurality of entities. In selected embodiments, the relationship map is generated by storing the business graph data structure in a Neo4J graph database management system. In such embodiments, the business graph data structure includes a plurality of graph nodes connected via graph edges which represent relationships between the nodes. Finally, the device applies one or more query processing services to generate a search report in response to a business connection search query from the first user, where the search report comprises an aggregated view of a contact panel and a news panel, where the contact panel is populated with business connection recommendations from the business graph data structure which correspond to the business connection search query, and where the news panel is populated with one or more newsfeed articles which correspond to the business connection search query and which are tagged with a sentiment score and one or more entity and topic tags. In selected embodiments, the query processing services are applied by applying natural language processing services selected from a group consisting of a query parsing service, a fuzzy search service, a sentiment analysis service, a classification service, and a topic identification service.

The present invention may be a system, a method, and/or a computer program product such that selected embodiments include software that performs certain tasks. The software discussed herein may include script, batch, or other executable files. The software may be stored on a machine-readable or computer-readable storage medium, and is otherwise available to direct the operation of the computer system as described herein and claimed below. In one embodiment, the software uses a local or database memory to implement the data transformation and data structures so as to automatically detect business connection opportunities from multiple business connection services by identifying relevant newsfeed and corporate data with sentiment scoring and tagged topics and entities. The local or database memory used for storing firmware or hardware modules in accordance with an embodiment of the invention may also include a semiconductor-based memory, which may be permanently, removably or remotely coupled to a microprocessor system. Other new and various types of computer-readable storage media may be used to store the modules discussed herein. Additionally, those skilled in the art will recognize that the separation of functionality into modules is for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module.

In addition, selected aspects of the present invention may take the form of an entirely hardware embodiment, an entirely software embodiment (including firmware, resident software, micro-code, etc.), or an embodiment combining software and/or hardware aspects that may all generally be referred to herein as a “circuit,” “module” or “system.” Furthermore, aspects of the present invention may take the form of computer program product embodied in a computer readable storage medium or media having computer readable program instructions thereon for causing a processor to carry out aspects of the present invention. Thus embodied, the disclosed system, a method, and/or a computer program product is operative to improve the design, functionality and performance of software programs by automatically detecting and recommending business connection recommendations with relevant, timely and supportive sales intelligence.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a Public Switched Circuit Network (PSTN), a packet-based network, a personal area network (PAN), a local area network (LAN), a wide area network (WAN), a wireless network, or any suitable combination thereof. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Visual Basic.net, Ruby, Smalltalk, C++ or the like, and conventional procedural programming languages, such as the “C” programming language, Hypertext Precursor (PHP), or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a sub-system, module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system described above is for purposes of example only, and may be implemented in any type of computer system or programming or processing environment, or in a computer program, alone or in conjunction with hardware. Various embodiments of the present may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. The system and method for generating business connection recommendations may be implemented in any type of computer system or programming or processing environment. It is contemplated that the system and method for generating business connection recommendations might be run on a stand-alone computer system, such as the one described above. The system and method for generating business connection recommendations might also be run from a server computer systems system that can be accessed by a plurality of client computer systems interconnected over an intranet network. Finally, the system and method for generating business connection recommendations may be run from a server computer system that is accessible to clients over the Internet.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method performed by a device having a business connection recommendation engine, comprising:
receiving, by the device, connection network data from first and second social networking systems, where the connection network data defines a first plurality of entities connected to at least a first user by a plurality of social network connections;
preprocessing, by the device, newsfeed and/or corporate data with a plurality of natural language processing services to identify a second plurality of entities and topics in the newsfeed and/or corporate data;
generating, by the device, a relationship map as a business graph data structure which defines relationships between at least the first user and each entity in the first plurality of entities and the second plurality of entities; and
applying, by the device, one or more query processing services to generate a search report in response to a business connection search query from the first user, where the search report comprises an aggregated view of a contact panel and a news panel, where the contact panel is populated with business connection recommendations from the business graph data structure which correspond to the business connection search query, and where the news panel is populated with one or more newsfeed articles which correspond to the business connection search query and which are tagged with a sentiment score and one or more entity and topic tags.

2. The method of claim 1, where the first and second social networking systems comprise a LinkedIn system and a Facebook system.

3. The method of claim 1, where the connection network data defines the first plurality of entities connected to the first user and/or to one or more additional employees of a company that employs the first user.

4. The method of claim 1, where preprocessing the newsfeed and/or corporate data comprises applying natural language processing services selected from a group consisting of a sentiment analysis service, a classification service, and a topic identification service.

5. The method of claim 1, where preprocessing the newsfeed and/or corporate data comprises applying natural language processing services selected from a group consisting of a Google NLP service and a CodeNation cognition service.

6. The method of claim 1, where generating the relationship map comprises storing the business graph data structure in a Neo4J graph database management system.

7. The method of claim 6, where the business graph data structure comprises a plurality of graph nodes connected via graph edges which represent relationships between the nodes.

8. The method of claim 1, where applying one or more query processing services comprises applying natural language processing services selected from a group consisting of a query parsing service, a fuzzy search service, a sentiment analysis service, a classification service, and a topic identification service.

9. A computer program product comprising at least one recordable medium having stored thereon executable instructions and data which, when executed by at least one processing device, cause the at least one processing device to:
receive connection network data from first and second social networking systems, where the connection network data defines a first plurality of entities connected to at least a first user by a plurality of social network connections;
preprocess newsfeed and/or corporate data with a plurality of natural language processing services to identify a second plurality of entities and topics in the newsfeed and/or corporate data;
generate a relationship map as a business graph data structure which defines relationships between at least the first user and each entity in the first plurality of entities and the second plurality of entities; and
apply one or more query processing services to generate a search report in response to a business connection search query from the first user, where the search report comprises an aggregated view of a contact panel and a news panel, where the contact panel is populated with business connection recommendations from the business graph data structure which correspond to the business connection search query, and where the news panel is populated with one or more newsfeed articles which correspond to the business connection search query and which are tagged with a sentiment score and one or more entity and topic tags.

10. The computer program product of claim 9, where the first and second social networking systems comprise a LinkedIn system and a Facebook system.

11. The computer program product of claim 9, where the connection network data defines the first plurality of entities connected to the first user and/or to one or more additional employees of a company that employs the first user.

12. The computer program product of claim 9, where the computer readable program, when executed on the system, causes the at least one processing device to preprocess the newsfeed and/or corporate data by applying natural language processing services selected from a group consisting of a sentiment analysis service, a classification service, and a topic identification service.

13. The computer program product of claim 9, where the computer readable program, when executed on the system, causes the at least one processing device to preprocess the newsfeed and/or corporate data by applying natural language processing services selected from a group consisting of a Google NLP service and a CodeNation cognition service.

14. The computer program product of claim 9, where the computer readable program, when executed on the system, causes the at least one processing device to generate the relationship map by storing the business graph data structure in a Neo4J graph database management system.

15. The computer program product of claim 14, where the business graph data structure comprises a plurality of graph nodes connected via graph edges which represent relationships between the nodes.

16. The computer program product of claim 9, where the computer readable program, when executed on the system, causes the at least one processing device to apply one or more query processing services by applying natural language processing services selected from a group consisting of a query parsing service, a fuzzy search service, a sentiment analysis service, a classification service, and a topic identification service.

17. A system comprising:
one or more processors;
a memory coupled to at least one of the processors; and
a set of instructions stored in the memory and executed by at least one of the processors to enhance operable functionality of a software program for recommending business recommendations, wherein the set of instructions are executable to perform actions of:
receiving connection network data from first and second social networking systems, where the connection network data defines a first plurality of entities connected to at least a first user by a plurality of social network connections;
preprocessing newsfeed and/or corporate data with a plurality of natural language processing services to identify a second plurality of entities and topics in the newsfeed and/or corporate data;
generating a relationship map as a business graph data structure which defines relationships between at least the first user and each entity in the first plurality of entities and the second plurality of entities; and
applying one or more query processing services to generate a search report in response to a business connection search query from the first user, where the search report comprises an aggregated view of a contact panel and a news panel, where the contact panel is populated with business connection recommendations from the business graph data structure which correspond to the business connection search query, and where the news panel is populated with one or more newsfeed articles which correspond to the business connection search query and which are tagged with a sentiment score and one or more entity and topic tags.

18. The system of claim 17, where the first and second social networking systems comprise a LinkedIn system and a Facebook system, and where the connection network data defines the first plurality of entities connected to the first user and/or to one or more additional employees of a company that employs the first user.

19. The system of claim 17, where preprocessing the newsfeed and/or corporate data comprises applying natural language processing services selected from a group consisting of a sentiment analysis service, a classification service, and a topic identification service, and where applying one or more query processing services comprises applying natural language processing services selected from a group consisting of a query parsing service, a fuzzy search service, a sentiment analysis service, a classification service, and a topic identification service.

20. The system of claim 17, where generating the relationship map comprises storing the business graph data structure in a Neo4J graph database management system, where the business graph data structure comprises a plurality of graph nodes connected via graph edges which represent relationships between the node.
